(19) United States
(12) Patent Application Publication
(10) Pub. No.: US 2003/0208581 A1
(43) Pub. Date: Nov. 6, 2003

(54) Discovery of fabric devices using information from devices and switches

(76) Inventors: Paul D. von Behren, Boulder, CO (US); Jeffrey A. Hanson, Westminster, CO (US)

Correspondence Address: Michael A. DeSanctis, BLAKELY, SOKOLOFF, TAYLOR & ZAFMAN LLP, 12400 Wilshire Boulevard, Seventh Floor, Los Angeles, CA, 90025-1026, US

(21) Appl. No.: 10/137,590

(22) Filed: May 2, 2002

(51) Int. Cl. G06F 15/173

(52) U.S. Cl. 709/223

(57) ABSTRACT

Apparatus and methods are described for building and maintaining a detailed inventory of Storage Area Network (SAN) devices. According to one embodiment of the invention, the topology of a SAN is discovered by determining the nodes associated with the SAN. A repository host receives in-band and/or out-of-band transmissions including information regarding Input/Output (I/O) adapters associated with the non-repository hosts on the SAN. Those of the SAN nodes that correspond to storage devices are identified and associations between the hosts and the storage devices are identified based upon the information regarding I/O adapters. Finally, information regarding the characteristics of a storage device is gathered by causing an I/O adapter of a host associated with the storage device to issue one or more interconnect protocol commands to the storage device via an in-band SAN transmission.

### COPYRIGHT NOTICE

Contained herein is material that is subject to copyright protection. The copyright owner has no objection to the facsimile reproduction of the patent disclosure by any person, as it appears in the Patent and Trademark Office patent files or records, but otherwise reserves all rights to the copyright whatsoever.

### BACKGROUND OF THE INVENTION

1. Field of the Invention

The invention relates generally to Storage Resource Management. More particularly, the invention relates to discovery of Storage Area Network (SAN) devices using topology information from switches and results of interconnect protocol inquiries of the SAN devices.

2. Description of the Related Art

Storage Area Networks (SANs) have begun to replace the traditional server-to-storage device model of data management. SANs are predominately implemented using Fibre Channel (FC). As SANs increase in size and complexity, the FC topology typically chosen is FC Fabric. A SAN may include a Fabric containing a large number of devices (e.g., optical libraries, disks, and tape libraries) and hosts (e.g., servers, workstations, or personal computers) interconnected using switches.

As Fabric environments are implemented, conventional approaches to device discovery become problematic. Although a device may be connected to multiple hosts, it is likely that this device is allocated for use on a single host (or a few hosts in a cluster environment). The prior art approach to device discovery is for each host to discover all attached devices and build low-level support structures for each. The administrator is trusted to only mount file systems on a device from appropriate hosts. In a Fabric environment, running discovery from every host is inefficient. Additionally, it can be disruptive if a device is actively in use.

Another method of discovery used in the prior art is through switches. Switches perform a discovery process of their own and typically expose the results through TCP/IP interfaces. This allows management tools to view storage independently of hosts, including unallocated storage. Unfortunately, the switch discovery results are not adequate for use by storage management applications. One limitation is that the types of devices (e.g., make and model) are not included in the switch discovery results. Additionally, the switch discovery results are not consistent for different devices. For example, a typical Just a Bunch Of Disks (JBOD) array with eight disks will show up as eight FC nodes (and more if it includes enclosure devices). However, a Redundant Array of Independent Disks (RAID) subsystem with eight Logical Unit Numbers (LUNs) is represented as a single FC node. An administrator expects these two devices to be treated similarly and is therefore likely to be confused by the different representations in terms of number of nodes. Unfortunately, there is not enough information available to the switch to allow a storage management application to provide a more consistent view.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 illustrates an exemplary enterprise storage network environment in which embodiments of the present invention may be implemented.

FIG. 2 illustrates an exemplary Storage Area Network (SAN) environment in which embodiments of the present invention may be implemented.

FIG. 3 is an example of a computer system upon which one embodiment of the present invention may be implemented.

FIG. 4 is a flow diagram illustrating fabric device discovery processing according to one embodiment of the present invention.

### DETAILED DESCRIPTION OF THE INVENTION

Apparatus and methods are described for building and maintaining a detailed inventory of Storage Area Network (SAN) devices. Broadly stated, according to embodiments of the present invention a scalable fabric device discovery mechanism efficiently combines topology information from switches with results of interconnect protocol inquiries of the fabric devices. According to one embodiment, when a storage management application starts up, it communicates with switches using out-of-band transmissions to get a list of FC nodes attached to each switch. The storage management application also asks agents running on each cooperating host to provide it with a list of Host Bus Adapters (HBAs) connected to that host. Using the combination of this information, the storage management application can recognize which nodes are switches and which are HBAs. The remainder of the nodes can be treated as devices. The storage management application may then select a host and path for each device and request the host agent to retrieve additional device details using in-band transmissions. Advantageously, in this manner, less disruptive commands (out-of-band transmissions) are used to identify paths from various hosts to FC hardware and FC device details may be acquired via one host and path using interconnect protocol commands.

According to another embodiment, the storage management application may also respond to fabric events. For example host agents may report the addition or removal of a fabric node to cause the storage management application to change its view of the SAN topology. Advantageously, in this manner, fabric events may be used to facilitate tracking of dynamic configuration changes as a result of hot swap and/or hardware failures, for example.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product that may include one or more machine-readable mediums having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media / machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Importantly, while embodiments of the present invention will be described with reference to a centrally managed discovery approach for building a detailed inventory of FC fabric devices and their characteristics using discovery results from switches and results of Small Computer System Interface (SCSI) interrogations of the FC fabric devices, the apparatus and methods described herein are equally applicable to various other types of devices and interconnect protocols.

Terminology

Before describing an exemplary environment in which various embodiments of the present invention may be implemented, some terms that will be used throughout this application will briefly be defined.

A Storage Area Network (SAN) is a network that links servers or workstations to storage devices, such as disk arrays and tape-backup systems. A SAN is typically implemented over Fibre Channel.

An in-band transmission generally refers to a transmission using the storage network. For example, an in-band transmission on a SAN connected by Fibre Channel is a transmission that occurs using the Fibre Channel interface.

An out-of-band transmission generally refers to a transmission that occurs outside the storage network, typically over Ethernet.

An I/O adapter generally refers to a physical connection or device between an I/O bus an a host system's memory system. A Host Bus Adapter (HBA) is a type of I/O adapter that connects a computer's memory system with the Fibre Channel network. Host systems typically contain one or more HBAs, each of which may have one or more Fibre Channel ports.

Network Overview

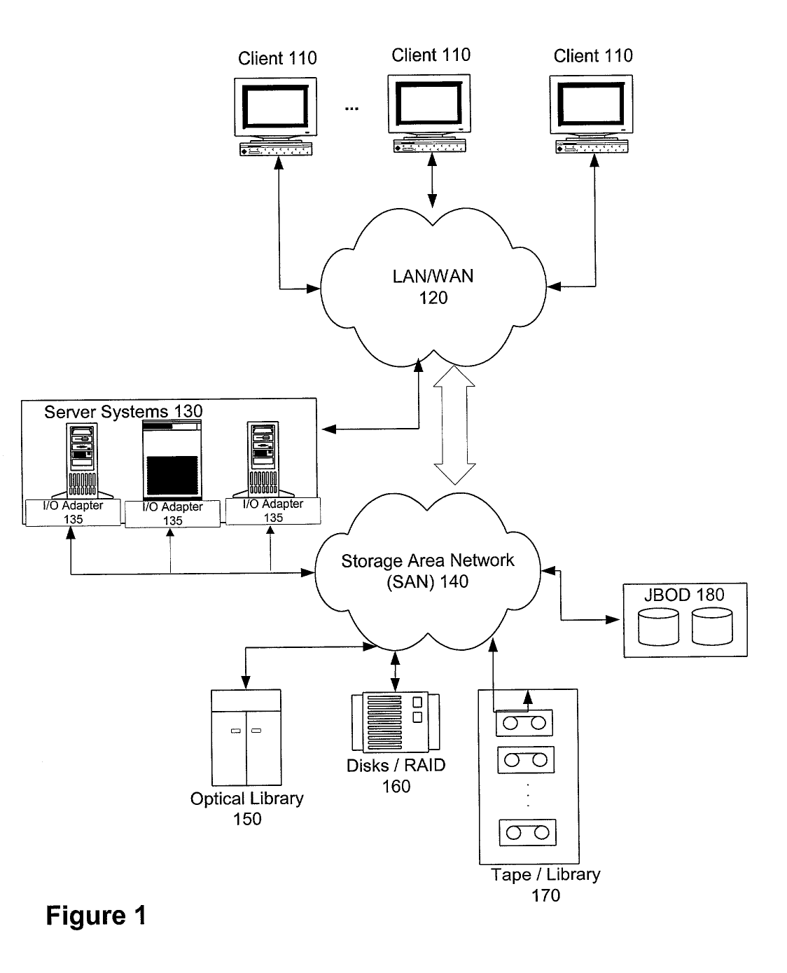

The present invention may be included within a network such as that illustrated in FIG. 1. According to the embodiment depicted in FIG. 1, server systems 130 may be communicatively coupled to clients 110 through a communications medium 120, such as a local area network (LAN) or a wide area network (WAN). Server systems 130 may also be communicatively coupled through I/O adapters 135 to a Storage Area Network (SAN) 140. The SAN 140 may be communicatively coupled to the LAN/WAN 120 through one or more interconnect entities, such as a switch. Other types of interconnect entities may be used.

Various kinds of storage devices, such as such as optical library 150, Disks/Raid 160, Tape/Library 170, and JBOD 180, may be connected to the SAN 140. These storage devices are merely illustrative of the types of storage devices that can be located on the SAN 140. Other types of storage devices may also be connected to the SAN 140.

Exemplary SAN

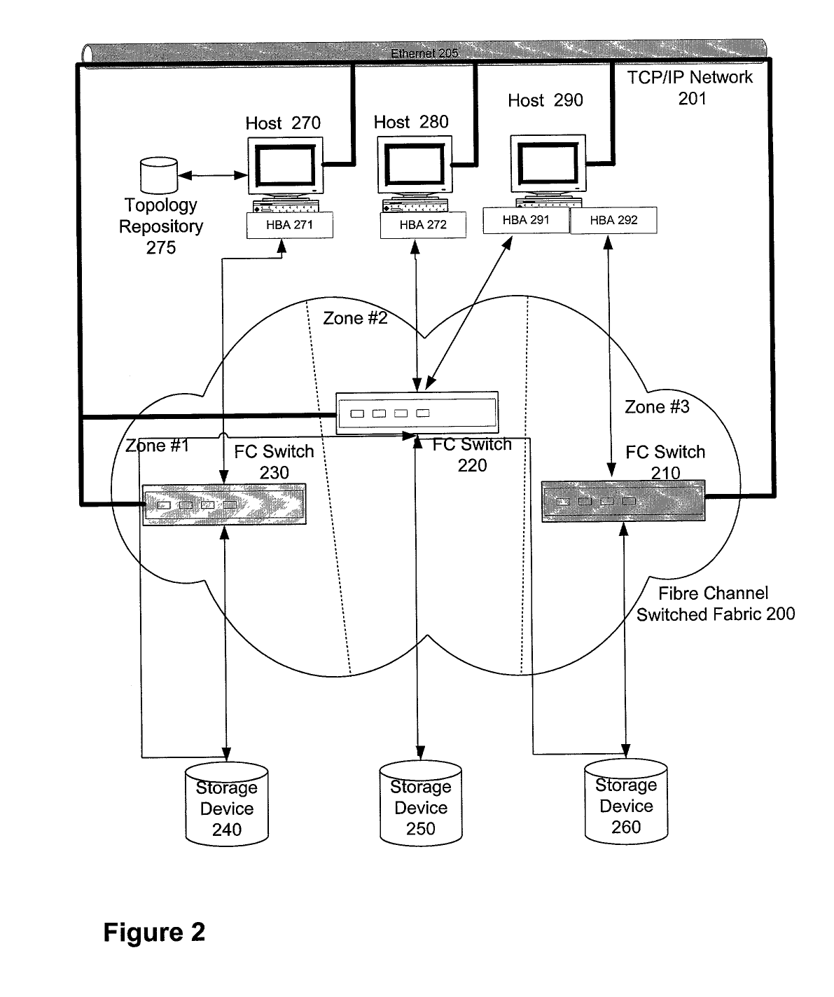

An exemplary SAN in which features of the present invention may be implemented will now be described with reference to FIG. 2. In FIG. 2, LAN/WAN 120 is implemented on a TCP/IP Network 201. It should be appreciated that other types of LAN/WAN networks, such as Token Ring, may also be utilized. As shown in FIG. 2, TCP/IP Network 201 may be implemented over Ethernet 205. Other types of physical connections may also be used. Hosts 270, 280, 290, and FC Switches 210, 220, 230 are communicatively coupled to TCP/IP Network 201.

SAN 140 is implemented on a Fibre Channel Switched Fabric 200. Fibre Channel Switched Fabric 200 is divided into three zones. Zone #1 is controlled by FC Switch 230. Zone #2 is controlled by FC Switch 220. Zone #3 is controlled by FC Switch 210.

Host 270 is communicatively coupled to FC Switch 230 via Host Bus Adapter 271. Host 280 is communicatively coupled to FC Switch 220 via Host Bust Adapter 272. Host 290 is communicatively coupled to FC Switch 220 via Host Bust Adapter 291 and is also communicatively coupled to FC Switch 210 via Host Bus Adapter 292. It should be appreciated that other configurations are possible. For example, multiple hosts can be connected to one switch or multi-ported HBA's may be used to connect the same host to different switches. Additionally, the Fibre Channel Switched Fabric 200 may be configured to contain additional or fewer zones.

Storage Devices 240, 250, and 260 are also a part of the Fibre Channel Switched Fabric 200. Storage Device 240 is communicatively coupled to FC Switch 230 and FC Switch 220. Storage Device 250 is communicatively coupled to FC Switch 220. Storage Device 260 is communicatively coupled to FC Switch 220 and FC Switch 210. In alternate embodiments, additional or fewer storage devices may be connected to a switch.

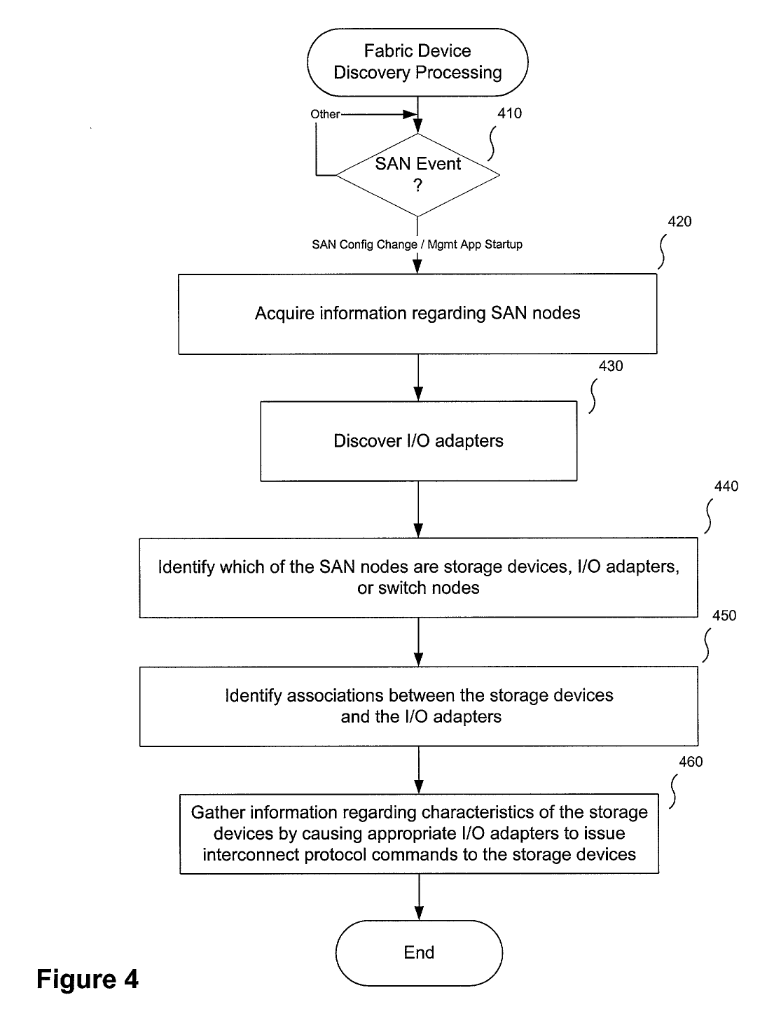

According to one aspect of the present invention, a host 270 may be designated a repository host and coordinate device discovery on the Fibre Channel Switched Fabric 200. This host 270 may maintain a centralized topology repository 275 about nodes on the Fibre Channel Switched Fabric 200. A detailed description of the novel device discovery process is described with reference to FIG. 4 below.

Computer System Overview

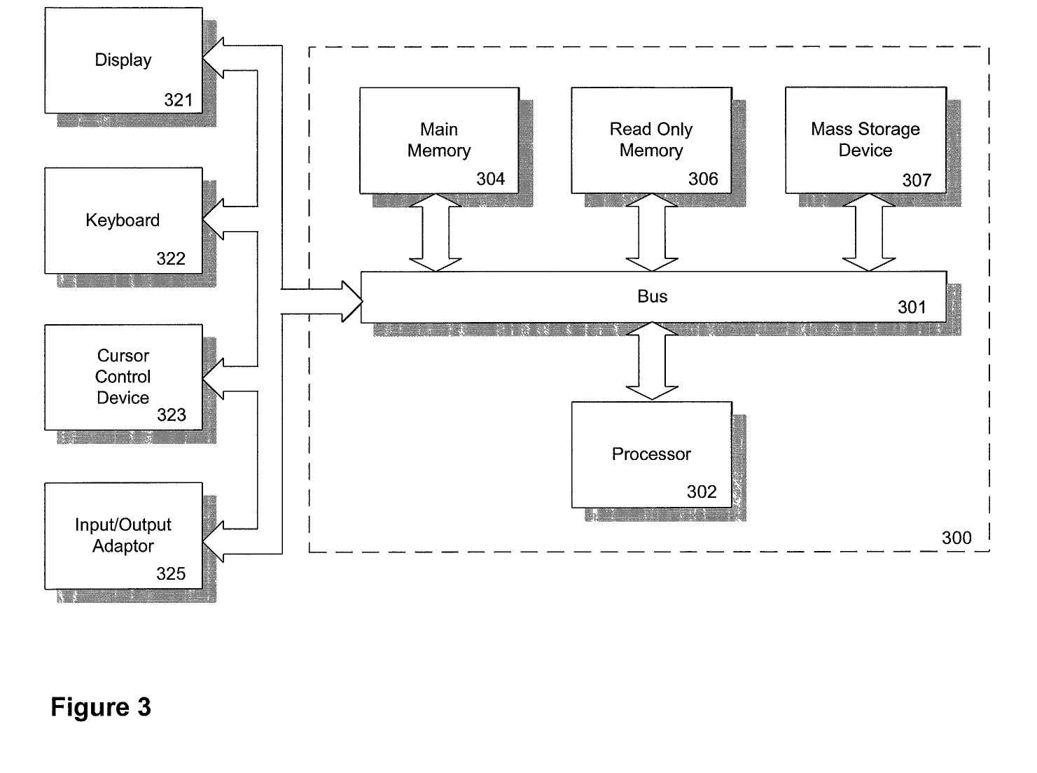

A computer system 300, representing an exemplary client, server, or host, in which features of the present invention may be implemented will now be described with reference to FIG. 3. Computer system 300 comprises a bus or other communication means 301 for communicating information, and a processing means such as processor 302 coupled with bus 301 for processing information. Computer system 300 further comprises a random access memory (RAM) or other dynamic storage device 304 (referred to as main memory), coupled to bus 301 for storing information and instructions to be executed by processor 302. Main memory 304 also may be used for storing temporary variables or other intermediate information during execution of instructions by processor 302. Computer system 300 also comprises a read only memory (ROM) and/or other static storage device 306 coupled to bus 301 for storing static information and instructions for processor 302.

A data storage device 307 such as a magnetic disk or optical disc and its corresponding drive may also be coupled to bus 301 for storing information and instructions. Computer system 300 can also be coupled via bus 301 to a display device 321, such as a cathode ray tube (CRT) or Liquid Crystal Display (LCD), for displaying information to a computer user. An alphanumeric input device 322, including alphanumeric and other keys, may be coupled to bus 301 for communicating information and/or command selections to processor 302. Another type of user input device is cursor control 323, such as a mouse, a trackball, or cursor direction keys for communicating direction information and command selections to processor 302 and for controlling cursor movement on display 321.

A communication device 325 is also coupled to bus 301 for accessing remote servers or other servers via the Internet, for example. The communication device 325 may include a modem, a network interface card, or other well-known interface devices, such as those used for coupling to an Ethernet, token ring, or other types of networks. In any event, in this manner, the computer system 300 may be coupled to a number of clients and/or servers via a conventional network infrastructure, such as a company's Intranet and/or the Internet, for example.

Device Discovery

A Fabric Device Discovery Process, according to one embodiment of the invention, will now be explained with reference to FIG. 4. In general, the methodology described herein employs information from switch agents to obtain more complete information regarding the fabric model.

If a SAN Event 410 that requires device discovery is detected, the fabric discovery process is initiated. SAN Events 410 that could initiate the process include the startup of a storage-management application or a SAN Configuration change. A SAN Configuration change may be detected by an SNMP message sent from a switch or a host agent reporting a dynamic configuration changes, such as a “hot swap” or hardware failure, over the network. Other events may also trigger the device discovery process. If the event reports that something has been added to the SAN, the device discovery process determines if a new node or a new path to an existing node has been added. Similarly, the device discovery process determines if an event for a removal describes the removal of a single path or the removal of an entire node when no other paths remain.

At block 420, information is acquired about the SAN nodes. According to one embodiment of the invention, a list of Fibre Channel nodes may be acquired by using an out-of-band communication (over the network, e.g., the TCP/IP network) with each switch on the SAN. The IETF RFC 2837 “Definitions of Managed Objects for the Fabric Element in Fibre Channel Standard” may be used to discover the Fibre Channel World Wide Names (WWNs) associated with the switch, the ports on the switch, and the nodes connected to the ports. In another embodiment, an inband transmission (over the Fibre Channel interface) to the switches may be used. If an inband transmission is used, the FC-GS 3 commands may be used to get the same information.

I/O adapters are discovered at block 430. In one embodiment, agents running on each host may provide a list of WWNs for HBAs connected to that host. In one embodiment, the information may be obtained over the network. This may be accomplished by using the operating system specific tool for listing attached hardware. For example, on Solaris the libg_fc library command can be used to get a list of Fibre Channel HBAs and their WWNs. In alternate embodiments, other methods may be used to acquire this information.

In block 440, the SAN nodes are identified as storage device nodes, I/O adapter nodes, or switch nodes. Using the combination of information at block 420 and block 430, switch nodes and I/O adapter nodes can be identified. The remainder of the nodes can be treated as storage devices.

Associations between the storage device nodes and the I/O adapter nodes is identified in block 450. This can be accomplished by using a combination of the information obtained in the previous blocks. In block 460, information is gathered regarding characteristics of the storage devices by causing appropriate I/O adapters to issue interconnect protocol commands to the storage devices. In one embodiment, a host and path for each device is selected. The host is then asked via TCP/IP to issue SCSI commands, such as the SCSI Inquiry command, to the storage device to obtain information on the type of device, make and model number. It should be appreciated that in alternate embodiments additional information may be obtained about each device. It should also be appreciated that other methods may be used to obtain the information about the storage device.

Advantageously, in this manner, less disruptive commands may be used to identify paths from various hosts to FC hardware and the repository host can then select one host and path to use for SCSI commands (such as Inquiry) to complete the desired details.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of discovering the topology of a Storage Area Network (SAN) comprising:
determining a plurality of nodes associated with the SAN, the plurality of nodes including a plurality of hosts and a plurality of storage devices;
receiving, at a repository host of the plurality of hosts from non-repository hosts of the plurality of hosts, in-band and/or out-of-band transmissions including information regarding Input/Output (I/O) adapters associated with the non-repository hosts, the repository host to manage a central repository of topology information and to coordinate discovery processing among the plurality of hosts;
identifying which of the plurality of nodes correspond to storage devices and identifying associations between the plurality of hosts and the plurality of storage devices based upon the information regarding I/O adapters;
for each of the identified storage devices, the repository host gathering information regarding one or more characteristics of the storage device by causing an I/O adapter of a host associated with the storage device to issue one or more interconnect protocol commands to the storage device via an in-band SAN transmission.

2. The method of claim 1, wherein said determining a plurality of nodes associated with the SAN comprises receiving topology discovery results from one or more interconnect entities in a Fibre Channel fabric of the SAN in response to name service commands issued from the repository host.

3. The method of claim 2, wherein the one or more interconnect entities comprise one or more Fibre Channel switches.

4. The method of claim 1, wherein the I/O adaptors comprise Host Bus Adaptors (HBAs).

5. The method of claim 4, wherein said identifying which of the plurality of nodes correspond to storage devices comprises determining which of the plurality of nodes are non-HBAs.

6. The method of claim 1, further comprising the repository host creating a topology repository by combining the information regarding the one or more characteristics of the identified storage devices with the information regarding I/O adaptors and the associations.

7. The method of claim 6, further comprising the repository host updating the topology repository in response to storage device configuration changes.

8. The method of claim 1, wherein in-band transmissions comprise SCSI commands.

9. The method of claim 1, wherein out-of-band transmissions comprise Transmission Control Protocol/Internet Protocol (TCP/IP) communications over Ethernet.

10. The method of claim 1, wherein the one or more characteristics of the storage device include one or more of manufacturer, type of storage device, or serial number.

11. The method of claim 1, wherein said gathering information regarding characteristics of the storage device comprises:
the repository host selecting a Host Bus Adaptor (HBA) associated with the storage device and in the same fabric zone of the storage device;
the repository host causing the selected HBA to issue a Small Computer System Interface (SCSI) Inquiry command to the storage device; and
the repository host extracting information relating to characteristics of interest from a response to the SCSI Inquiry command by the storage device.

12. A Storage Area Network (SAN) comprising:
a Fibre Channel network including one or more Fibre Channel switches, the one or more Fibre Channel switches to perform topology discovery;
a plurality of storage devices coupled to the Fibre Channel network to store data and serve as resources to SAN participants; and
a plurality of hosts coupled to each other via Ethernet and coupled to the Fibre Channel network to gain access to the plurality of storage devices, the plurality of hosts including
a repository host to coordinate discovery processing among the plurality of hosts and combine the results thereof with the results of the topology discovery by the one or more Fibre Channel switches to create a central repository of topology information relating to the SAN, and
a plurality of non-repository hosts to report information regarding their Host Bus Adaptors (HBAs) to the repository host and to assist the repository host in gathering information regarding characteristics of the plurality of storage devices by issuing SCSI Inquiry commands to designated storage devices at the request of the repository host.

13. A machine-readable medium having stored thereon data representing sequences of instructions, the sequences of instructions which, when executed by a repository host of a Storage Area Network (SAN), cause the repository host to create a central repository of topology information and to coordinate discovery processing among a plurality of other hosts of the SAN by:
determining a plurality of nodes associated with the SAN, the plurality of nodes including a plurality of hosts and a plurality of storage devices;
receiving from non-repository hosts of the plurality of hosts, in-band and/or out-of-band transmissions including information regarding Input/Output (I/O) adapters associated with the non-repository hosts;
identifying which of the plurality of nodes correspond to storage devices and identifying associations between the plurality of hosts and the plurality of storage devices based upon the information regarding I/O adapters;
for each of the identified storage devices, gathering information regarding one or more characteristics of the storage device by causing an I/O adapter of a host associated with the storage device to issue one or more interconnect protocol commands to the storage device via an in-band transmission; and
combining the information regarding the one or more characteristics of the identified storage devices with the information regarding I/O adaptors and the associations to form the central repository of topology information.

14. The machine-readable medium of claim 13, wherein said determining a plurality of nodes associated with the SAN comprises receiving topology discovery results from one or more interconnect entities in a Fibre Channel fabric of the SAN in response to name service commands issued from the repository host.

15. The machine-readable medium of claim 14, wherein the one or more interconnect entities comprise one or more Fibre Channel switches.

16. The machine-readable medium of claim 13, wherein the I/O adaptors comprise Host Bus Adaptors (HBAs).

17. The machine-readable medium of claim 16, wherein said identifying which of the plurality of nodes correspond to storage devices comprises determining which of the plurality of nodes are non-HBAs.

18. The machine-readable medium of claim 13, wherein in-band transmissions comprise SCSI commands.

19. The machine-readable medium of claim 13, wherein out-of-band transmissions comprise Transmission Control Protocol/Internet Protocol (TCP/IP) communications over Ethernet.

20. The machine-readable medium of claim 13, wherein the one or more characteristics of the storage device include one or more of manufacturer, type of storage device, or serial number.
